(19) United States
(12) Patent Application Publication
(10) Pub. No.: US 2018/0081088 A1
(43) Pub. Date: Mar. 22, 2018

(54) DISPLAY DEVICE PROTECTING COVER AND DISPLAY DEVICE COMPRISING THEREOF

(71) Applicant: SAMSUNG DISPLAY CO., LTD., Yongin-si (KR)

(72) Inventors: Seong Jin HWANG, Yongin-si (KR); Myung Hwan KIM, Yongin-si (KR); Ji Yeon KIM, Yongin-si (KR); Ik Hyung PARK, Yongin-si (KR); Dae Ho YOON, Yongin-si (KR)

(21) Appl. No.: 15/709,506

(22) Filed: Sep. 20, 2017

(30) Foreign Application Priority Data
Sep. 21, 2016 (KR) 10-2016-0120628

(51) Int. Cl. G02B 1/14; C03C 17/32; C03C 17/00

(52) U.S. Cl. CPC G02B 1/14; C03C 2217/78; C03C 17/007; C03C 17/322

(57) ABSTRACT

A protecting cover includes a cover substrate, and a coating layer provided on the cover substrate, wherein the coating layer includes a matrix and a filler embedded in the matrix.

### CROSS-REFERENCE TO RELATED APPLICATION

Korean Patent Application No. 10-2016-0120628, filed on Sep. 21, 2016, in the Korean Intellectual Property Office, and entitled: “Display Device,” is incorporated by reference herein in its entirety.

### BACKGROUND

### 1. Field

Embodiments relate to a display device protecting cover and a display device including the display device protecting cover.

### 2. Description of the Related Art

Recently, flexible display devices using a flat panel display device have been developed. The flat panel display devices generally include a liquid crystal display (LCD), an organic light-emitting diode (OLED), or an electrophoretic display (EPD).

### SUMMARY

Embodiments are directed to a protecting cover including a cover substrate, and a coating layer on the cover substrate. The coating layer includes a matrix and a filler embedded in the matrix.

The matrix may include at least one of an epoxy acrylate resin, a polyester acrylate resin, a polyether acrylate resin, a urethane acrylate resin, an acrylic acrylate resin, an unsaturated polyester, a urethane resin, an acrylonitrile-butadiene-styrene (ABS) resin, and a rubber.

The filler may include at least one of glass beads, glass fibers, and silica.

The cover substrate may include at least one of glass, aluminosilicate, borosilicate, and boroaluminosilicate. The cover substrate may include an ion-exchanged chemical strengthening layer.

The coating layer may be an elastic modulus of 1.52 GPa to 5.0 GPa.

A difference between a refractive index of the coating layer or a refractive index of the cover substrate and a refractive index of the filler may be less than 0.3.

The protecting cover may further include an adhesive layer on the coating layer.

The adhesive layer may have a storage modulus of 80 MPa to 120 MPa.

The cover substrate may have a thickness of 10 μm to 150 μm.

The protecting cover may be bendable to a radius of curvature of 4.5 mm or less without breaking or peeling of the cover substrate.

A ratio of a volume of the matrix to a sum of the volume of the matrix and a volume of the filler may be 80% to 100%.

The protecting cover may have an impact resistance of at least 6 cm in a test in which a pen of 5.7 g is dropped onto the protecting cover.

Embodiments are also directed to a display device including a display panel displaying an image and a protecting cover provided on the display panel. The protecting cover includes a cover substrate and a coating layer on the cover substrate, the coating layer including a matrix and a filler.

The display device may further include an adhesive layer between the coating layer and the display panel.

The coating layer may be between the cover substrate and the display panel.

The display device may have flexibility.

The matrix may include at least one of an epoxy acrylate resin, a polyester acrylate resin, a polyether acrylate resin, a urethane acrylate resin, an acrylic acrylate resin, an unsaturated polyester, a urethane resin, an acrylonitrile-butadiene-styrene (ABS) resin, and a rubber.

The filler may include at least one of glass beads, glass fibers, and silica.

The cover substrate may include at least one of glass, aluminosilicate, borosilicate, and boroaluminosilicate. The cover substrate may include an ion-exchanged chemical strengthening layer.

### BRIEF DESCRIPTION OF THE DRAWINGS

Features will become apparent to those of skill in the art by describing in detail exemplary embodiments with reference to the attached drawings in which:

FIG. 1 illustrates a cross-sectional view of a protecting cover according to an embodiment;

FIG. 2 illustrates a cross-sectional view of a protecting cover in a folded state according to an embodiment;

FIG. 3 illustrates a cross-sectional view of a protecting cover according to an embodiment; and

FIG. 4 illustrates a cross-sectional view of a display device according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

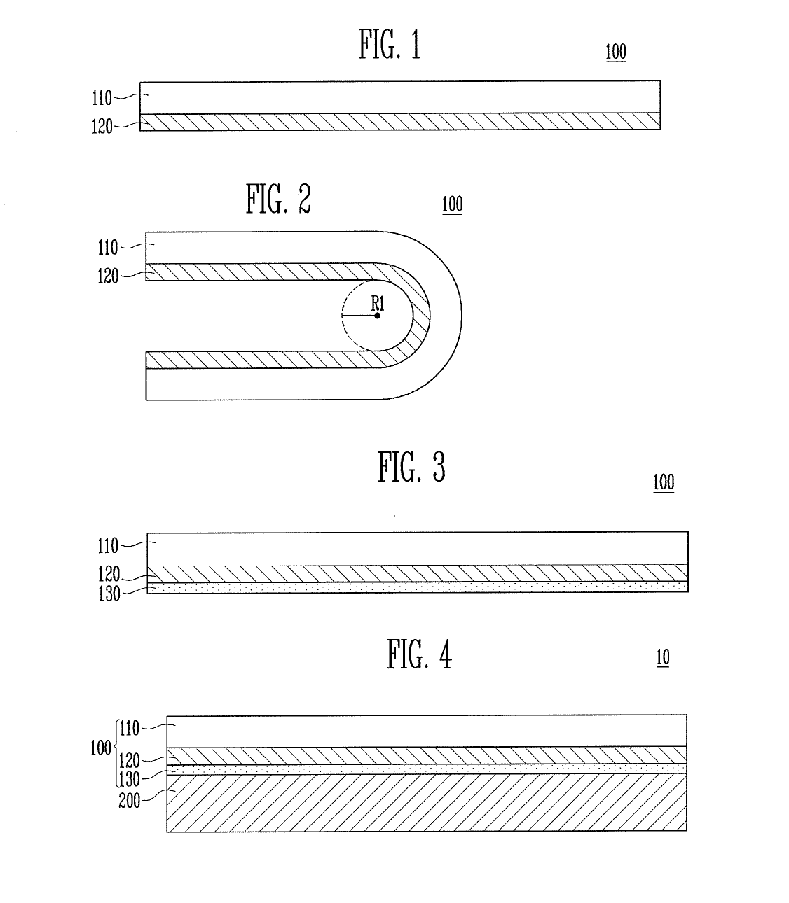

FIG. 1 illustrates a cross-sectional view of a protecting cover 100 according to an embodiment. Referring to FIG. 1, the protecting cover 100 according to an embodiment may include a cover substrate 110 and a coating layer 120 provided on the cover substrate 110. The coating layer 120 may include a matrix and a filler.

The protecting cover 100 may protect a display device from an external impact such as scratching of the protecting cover 100 or a surface impact or point impact applied to the protecting cover 100. The term “point impact” may refer to an impact resulting from applying high pressure to a narrow area. The term “surface impact” may refer to an impact resulting from applying high pressure to a relatively larger area. For example, a point impact may be generated when the display device is intensively touched by a sharp object such as a sharp pen. A surface impact may be generated when the display device is pressed by a heavy object, for example, during transportation. The protecting cover 100 may withstand the point impact. However, when the display device is intensively touched by a sharp object, the protecting cover 100 may be broken by impact applied to an extent that the protecting cover 100 cannot withstand. In such a case, fragments generated when the protecting cover 100 breaks may do harm to a user in addition to the display device. Therefore, the protecting cover 100 may be developed to prevent the scattering of the fragments when broken.

The protecting cover 100 may have various shapes. For example, the protecting cover 100 may have a rectangular shape, a square shape, a circular shape, an elliptical shape, a semicircular shape, or a semi-elliptical shape.

The cover substrate 110 may form the structure of the protecting cover 100. For example, the coating layer 120 and the like included in the protecting cover 100 may be formed on the cover substrate 110.

The cover substrate 110 may be made of a suitable material having excellent durability, surface smoothness and transparency. For example, the cover substrate 110 may be made of at least one material selected from glass, aluminosilicate, borosilicate, and boroaluminosilicate.

The cover substrate 110 may have a thickness of about 10 μm to about 150 μm. When the thickness of the cover substrate 110 exceeds 150 μm, a repulsive force against deformation may excessively increase, and thus it may be difficult to bend the cover substrate 110 and the protecting cover 100. When the thickness of the cover substrate 110 is less than 10 μm, the cover substrate 110 may have a low strength, such that the cover substrate 110 may be susceptible to damage. If the cover substrate 110 is damaged, flaws and cracks may be formed, propagated, or broken in the cover substrate 110, such that the cover substrate 110 may not be usable for its intended purpose.

The cover substrate 110 having the above thickness may be formed by performing a slimming process. The slimming process may include reducing the thickness of the cover substrate 110 using a chemical or a mechanical method. The slimming process may be performed on one surface or on both surfaces of a mother substrate of the cover substrate 110. When the chemical method is used, a sponge containing an etching liquid may be placed in contact with a surface of the mother substrate of the cover substrate 110, or the etching liquid may be repeatedly sprayed in a predetermined area.

The shape of the cover substrate 110 may vary depending on the shape of the protecting cover 100. Thus, a mother substrate of the slimmed cover substrate 110 may be formed into various shapes by a shaping process. The shaping process may include a cutting operation or a chamfering operation.

The cover substrate 110 may include an ion-exchanged chemical strengthening layer. A chemical strengthening layer may be formed by performing a chemical strengthening treatment on an outer surface of the cover substrate 110. The chemical strengthening treatment may include an ion exchange process. The term “ion exchange process” refers to a process in which a cation positioned at or close to a glass surface at a lower temperature than a deformation temperature of the cover substrate 110 is replaced with another cation of the same valence. For example, an alkali metal cation such as Na⁺ and Li⁺ in the glass may be exchanged for a cation such as K⁺ by performing the ion exchange process. The ion exchange process may include soaking the cover substrate 110 in an ion exchange salt and heating the soaked cover substrate 110. The ion exchange salt may include ions that are to be exchanged with ions in the cover substrate 110. The ions included in the ion exchange salt may be K⁺, and the ions in the cover substrate 110 to be exchanged may be N⁺ or L⁺. The ion exchange salt may be in a nitrate form. When the cover substrate 110 soaked in the ion exchange salt is heated, the ions in the ion exchange salt may diffuse into the cover substrate 110 through the surface thereof. The cover substrate 110 may be heated at about 370° C. to about 450° C. for about 1 hour to about 6 hours.

When the chemical strengthening layer is formed on the cover substrate 110, a bending rigidity of the cover substrate 110 may be lowered, and the cover substrate 110 and the protecting cover 100 may be more easily curved or folded. The chemical strengthening layer may provide a tensile stress profile that extends from a surface of the cover substrate 110 to a predetermined depth.

The chemical strengthening may be performed on one surface or on both surfaces of the cover substrate 110. The chemical strengthening may be performed symmetrically or asymmetrically on a front surface and a rear surface of the cover substrate 110. When the cover substrate 110 is generally folded in a specific direction, the chemical strengthening may be asymmetrically performed. For example, when the cover substrate 110 is typically folded in only one direction, compressive stress may be applied to a surface where both ends are opposite to each other, and tensile stress may be applied to a surface opposite to the surface where both ends are opposite to each other. When different types of stress are typically applied to both surfaces of the cover substrate 110 as described above, the chemical strengthening may be asymmetrically performed.

A depth of the chemical strengthening layer may be from about 1 μm to about 15 μm. When the depth of the chemical strengthening layer is less than about 1 μm, the effect of improving strength by the chemical strengthening may be insignificant. When the depth of the chemical strengthening layer exceeds about 15 μm, stress control of the cover substrate 110 may be difficult. When the chemical strengthening is performed on both the front surface and the rear surface of the cover substrate 110, a thickness of the chemical strengthening layer formed on the front surface and a thickness of the chemical strengthening layer formed on the rear surface may be equal to or different from each other.

The coating layer 120 may be provided on the cover substrate 110. The coating layer 120 may improve an impact resistance of the protecting cover 100 and prevent the cover substrate 110 from being cracked and scattered.

The coating layer 120 may offset a tensile stress generated in the cover substrate 110 by an external impact. The coating layer 120 may prevent the cover substrate 110 from being broken. In addition, the coating layer 120 may absorb impact energy generated when the cover substrate 120 is cracked to prevent the scattering of imperceptible fragments. To this end, the coating layer 120 may have an elastic material and flexibility to be curvable, foldable or rollable.

According to FIG. 1, the coating layer 120 and the cover substrate 110 may be in direct contact with each other. The coating layer 120 may be formed on the cover substrate 110 by performing a coating process. For example, the coating layer 120 may be formed on the cover substrate 110 by slip coating, bar coating, spin coating, or the like.

A thickness of the coating layer 120 may be from about 5 μm to about 20 μm. When the thickness of the coating layer 120 is less than about 5 μm, the effects of preventing the scattering of cracked coating layer 120 and improving the impact resistance may not be sufficient. In addition, when the thickness of the coating layer 120 exceeds about 20 μm, the protecting cover 100 and the display device including thereof may become excessively thick. In addition, in such the case, the bending rigidity of the coating layer 120 may increase, and the degree of deformation of the cover substrate 110 due to the impact may increase, thereby increasing the tensile stress generated in the cover substrate 100.

An elastic modulus of the coating layer 120 may be from about 1.52 GPa to about 5.0 GPa. When the coating layer 120 has an elastic modulus of less than about 1.52 GPa, the degree of deformation of the cover substrate 110 due to the impact may increase, and the tensile stress applied to the cover substrate 110 may increase. When the coating layer 120 has an elastic modulus of greater than about 5.0 GPa, the coating layer 120 may not sufficiently absorb the impact energy generated when imperceptible glass fragments are scattered.

A difference between a refractive index of the coating layer 120 or a refractive index of the cover substrate 110 and a refractive index of the filler may be less than about 0.3. If the difference between the refractive index of the coating layer 120 or the refractive index of the cover substrate 110 and the refractive index of the filler were to be 0.3 or more, light could be undesirably diffracted at an interface between the cover substrate 110 and the coating layer 120. Such diffraction of the light could lower visibility of the image output from the display device, and the output image could appear blurry.

A light transmittance of the coating layer 120 may be about 70% or more. The light transmittance of the coating layer 120 may affect visibility when the image output from the display device is transmitted through the protecting cover 100 and the coating layer 120 to be visually recognized by eyes of a user. The coating layer 120 may have a light transmittance of about 70% or more, such that brightness of the light output from the display device may not be decreased.

The coating layer 120 may include a matrix and a filler embedded in the matrix.

The matrix may include at least one of an epoxy acrylate resin, a polyester acrylate resin, a polyether acrylate resin, a urethane acrylate resin, an acrylic acrylate resin, an unsaturated polyester, a urethane resin, an acrylonitrile-butadiene-resin and rubber. A refractive index of the matrix may be similar to a refractive index of the cover substrate 110. For example, a difference between the refractive index of the matrix and the refractive index of the cover substrate 110 may be less than 0.3. If a difference between the refractive index were to be 0.3 or more, the light transmittance of the protecting cover 100 could be decreased, which could cause a decrease in the visibility of the image output from the display device.

The filler may include at least one of glass beads, glass fibers, and silica. The filler may not affect the refractive index of the matrix such that, the refractive index of the matrix may be substantially the same as the refractive index of the coating layer 120. The filler may improve the impact resistance of the coating layer 120 and the protecting cover 100. The filler may be embedded in the matrix of the coating layer 120. Herein, the term “being embedded” indicates that the filler may form a specific pattern or is dispersed in the matrix. For example, when the filler includes glass fibers, the filler may be in a form of a plurality of lines parallel to one another in the matrix.

When the filler includes glass beads, a diameter of the glass beads may be from about 0.1 μm to about 1 μm. If the diameter of the glass beads is less than about 0.1 μm, light could be diffracted in the glass beads such that the light transmittance of the coating layer 120 could be significantly reduced. The effect of reducing the light transmittance by the glass beads may increase as the diameter of the glass beads decreases. When the diameter of the glass beads is more than about 1 μm, the number of glass beads may be relatively small at the same volume ratio, such that the effect of improving the impact resistance by the glass beads may be insignificant.

When the filler includes silica, a size of the silica may be from about 5 nm to about 20 nm. When the size of the silica is less than about 5 nm, the effect of improving the impact resistance by silica may be insignificant. When the diameter of the silica exceeds about 20 nm, the light transmittance of the coating layer 120 may be significantly reduced by the silica.

When the filler includes glass fibers, a diameter of the glass fibers may be from about 3 μm to about 5 μm. When the diameter of the glass fibers is less than about 3 μm, the effect of improving the impact resistance by the glass fibers may be insignificant. When the diameter of the glass fibers exceeds about 5 μm, the light transmittance of the coating layer 120 may be significantly reduced by the glass fibers.

A volume ratio between a matrix and a filler may be selected in consideration of impact resistance and light transmittance of the coating layer 120. Generally, when a volume occupied by the matrix increases, the light transmittance may increase, and when a volume occupied by the filler increases, the impact resistance may increase. The volume ratio between the matrix and the filler may be adjusted depending on the use of the display device to which the protecting cover 100 and the coating layer 120 are applied. Further, the filler may improve the impact resistance without adversely affecting the decrease in flexibility. As examples, a volume ratio of the matrix to the filler may be about 90:10 to about 70:30. When the filler includes a glass beads or silica, the volume ratio of the matrix and the filler may be about 90:10 to about 80:20.

The coating layer 120 may prevent the cracking of the cover substrate 110 when impact is applied to the protecting cover 100 as described above, thereby improving the impact resistance of the protecting cover 100. For example, the protecting cover 100 may have an impact resistance of at least about 6 cm on the basis that a pen weighing about 5.7 g is dropped onto the protecting cover. For example, when a pen weighing about 5.7 g is dropped from a height of 6 cm or less toward the protecting cover 100, the protecting cover is considered to have an impact resistance of at least 6 cm if the cover substrate 110 is not broken. Withstanding the impact by the pen in these circumstances may indicate that the protecting cover 100 according to an embodiment is particularly resistant to a point impact. When the pen falls freely onto the protecting cover 100, an impact area may be relatively narrow, such that the amount of impact caused by a falling pen may be concentrated on a narrow area. Therefore, the impact caused by the free fall of the pen may be the point impact.

FIG. 2 illustrates a cross-sectional view of a protecting cover in its folded state according to an embodiment. As shown in FIG. 2, the protecting cover 100 may have flexibility and may be curved or folded. The cover substrate 110 and the coating layer 120 may be curved or folded accordingly. The cover substrate 110 and the coating layer 120 may have a relatively small bending rigidity such that the protecting cover 100 may be easily curved or folded. The bending rigidity of each layer may be defined as following Equation 1.

BS∝E×TH³ [Equation 1]

In Equation 1, BS denotes a bending rigidity of each layer, E denotes an elastic modulus of each layer, and TH denotes a thickness of each layer. The bending rigidity of the cover substrate 110 may be in proportion to the cube of the thickness of the cover substrate 110. Therefore, in order for the cover substrate 110 to have a relatively small bending rigidity, the thickness of the cover substrate 110 may be relatively small.

As described above, in one embodiment, the cover substrate 110 may have a thickness of about 25 μm to about 100 μm. The cover substrate 110 according to the present disclosure that has the thickness in the above range may have a relatively small bending rigidity and be easily curved or folded.

When the protecting cover 100 is deformed by bending or folding, a repulsive force against deformation may be generated. The repulsive force against deformation of the cover substrate 110 in the protecting cover 100 may be defined as following Equation 2.

$$F = \frac{wt}{6 Y} {( 1.19814 Y \frac{t}{D - t} )}^{2} \qquad [ Equation 2 ]$$

In Equation 2, Y denotes a Young's modulus, t denotes a thickness of the cover substrate 110, w denotes a width of the cover substrate 110, and D denotes a width between both ends of the substrate facing each other when folded. The D value may substantially correspond to twice a radius of curvature of the cover substrate 110. Accordingly, the cover substrate 110 may be set to have a radius of curvature of about 1 mm to about 5 mm, and the corresponding D value may be satisfied. According to Equation 2, if other conditions are the same, a repulsive force when a thickness of the cover substrate 110 is about 100 μm and D is about 10 μm is approximately three times a repulsive force when a thickness of the cover substrate 110 is about 70 μm.

Therefore, when the cover substrate 110 and the protecting cover 100 are bent as shown in FIG. 2, a large repulsive force may be applied to the cover substrate 110. In addition, if the thickness of the cover substrate 110 were to be reduced to reduce the repulsive force and the bending rigidity of the cover substrate 110, the cover substrate 110 could be vulnerable to external impact.

The cover layer 120 according to an embodiment may improve the impact resistance of the cover substrate 110 as described above to compensate for a low impact resistance of the cover substrate 110. In addition, the cover layer 120 may prevent the scattering of fragments if the cover substrate 110 is cracked by external impact.

The protecting cover 100 according to an embodiment may have a radius of curvature R1 of about 4.5 mm or less. The cover substrate 110 may not break at the radius of curvature R1 and the cover layer 120 and the cover substrate 110 may not peel off at the radius of curvature R1.

FIG. 3 illustrates a cross-sectional view of a protecting cover according to an embodiment. Referring to FIG. 3, an adhesive layer 130 may be further provided on the coating layer 120. The adhesive layer 130 may attach the protecting cover 100 to another constituent element in the display device. The adhesive layer 130 may disperse stress generated between the protecting cover 100 and another constituent element of the display device. Accordingly, the repulsive force generated during the deformation of the display device including the protecting cover 100, such as when the display device is bent, may be reduced.

The adhesive layer 130 may have a predetermined adhesive strength, an elastic modulus, and creep characteristic under conditions at room temperature (25° C.) and a humidity of 50% so that the protecting cover 100 may not peel off from the display device. For example, the adhesive layer 130 may have an adhesion of at least 500 gf/in under the above conditions, and may have a storage modulus of about 80 MPa to about 120 MPa. The creep characteristic of the adhesive layer 130 under the above conditions may be 50% to 800%.

The storage modulus of the adhesive layer 130 may be in a range in which the layer 130 is optimized to reduce the repulsive force resulting from the deformation of the display device. The creep characteristic may be confirmed by measuring the initial deformation amount after applying a predetermined force to the adhesive layer 130, and measuring the final deformation amount after maintaining the same force. For example, the creep characteristic may be calculated by the formula of ‘(final deformation amount-initial deformation amount)/initial deformation amount’.

The adhesive layer 130 may include an optically clear adhesive (OCA), a pressure sensitive adhesive (PSA), or the like. In order for the image output from the display device to be transmitted through the adhesive layer 130 to be visually recognized by a user, the adhesive layer 130 may be optically transparent.

FIG. 4 illustrates a cross-sectional view of a display device 10 according to an embodiment. Referring to FIG. 4, the display device 10 according to an embodiment may include a display panel 200 for displaying an image and the protecting cover 100 provided on the display panel 200. The protecting cover 100 may include the cover substrate 110 and the coating layer 120 provided on the cover substrate 110. The coating layer 120 may include a matrix and a filler.

In the display device 10 according to FIG. 4, details of the protecting cover 100, the cover substrate 110, and the coating layer 120 are described above.

The display device 10 may have flexibility such that the display device 10 may be curvable, foldable, or rollable. The protecting cover 100 provided in the display device 10 may also be deformable accordingly.

The coating layer 120 may be provided between the cover substrate 110 and the display panel 200. The cover substrate 110 may be exposed to a user. The cover substrate 110 may have excellent interfacial properties. Accordingly, the excellent interface properties of the cover substrate 110 may be utilized by exposing the cover substrate 110. The excellent interfacial properties of the cover substrate 110 may affect the quality of an image output from the display device 10. For example, the image output from the display device 10 may be transmitted more clearly to a user when the cover substrate 110 is exposed. If the cover substrate 110 were to be covered with the coating layer 120 and not exposed to the user, such excellent interfacial properties might not be expressed.

An auxiliary sheet may further be provided on the cover substrate 110. The auxiliary sheet may be provided on the cover substrate 110 for a decorative purpose or the like. An adhesive layer may be provided between the auxiliary sheet and the cover substrate 110.

The display device 10 may be embodied in a suitable form such as an organic light emitting device, a liquid crystal device, an electrophoretic device, an electrowetting device, or the like. When the display device 10 is an organic light emitting device, the display panel 200 may include a light emitting material. When the display device 10 is a liquid crystal device, the display panel 200 may include liquid crystal molecules. In such a case, the display device 10 may include a separate light source.

The display device according to an embodiment may include pixels provided on a display area, a gate driver and a data driver for driving the pixels, and a timing controller for controlling the driving of the gate driver and the data driver.

Each pixel may be provided on the display area and may include a wire unit including a gate line, a data line, and a driving voltage line, a thin film transistor connected to the wire unit, an organic light emitting device connected to the thin film transistor, and a capacitor.

The gate line may extend in one direction. The data line may extend in another direction intersecting the gate line. The driving voltage line may extend in substantially the same direction as the data line. The gate line may transfer a gate signal to the thin film transistor, the data line may transfer a data signal to the thin film transistor, and the driving voltage line may provide the thin film transistor with a driving voltage.

The thin film transistor may include a driving thin film transistor for controlling the organic light emitting device and a switching thin film transistor for switching the driving thin film transistor. In some implementations, a pixel may include one thin film transistor and one capacitor. In some implementations, a pixel may include three or more thin film transistors and two or more capacitors.

In the switching thin film transistor, a gate electrode may be connected to the gate line, and a source electrode may be connected to the data line. A drain electrode of the switching thin film transistor may be connected to the gate electrode of the driving thin film transistor. The switching thin film transistor may transmit a data signal applied to the data line to the driving thin film transistor in accordance with the gate signal.

In the driving thin film transistor, a gate electrode may be connected to the drain electrode of the switching thin film transistor, a source electrode may be connected to the driving voltage line, and a drain electrode may be connected to the organic light emitting device.

The organic light emitting device may include a light emitting layer and a cathode and an anode opposite to each other with the light emitting layer interposed therebetween. The cathode may be connected to the drain electrode of the driving thin film transistor. A common voltage may applied to the cathode or the anode, and the light emitting layer may or may not emit light according to an output signal of the driving thin film transistor, thereby displaying an image. The light emitted from the light emitting layer may be white light or colored light.

The capacitor may be connected between the gate electrode and a second source electrode of the driving thin film transistor. The capacitor may charge and maintain a data signal input to the gate electrode of the driving thin film transistor.

The timing controller may receive a plurality of image signals and a plurality of control signals from an outside of the display device. The timing controller may convert a data format of the image signals according to an interface specification with the data driver, and provide the converted image signals to the data driver. In addition, the timing controller may generate a data control signal (e.g., an output start signal, a horizontal start signal, etc.) and a gate control signal (e.g., a vertical start signal, a horizontal clock signal, and a vertical clock bar signal). The data control signal may be provided to the data driver, and the gate control signal may be provided to the gate driver.

The gate driver may sequentially output the gate signals in response to the gate control signals provided from the timing controller. Accordingly, a plurality of pixels may be sequentially scanned by row in accordance with the gate signals.

The data driver may convert the image signals into the data signals in response to the data control signal provided from the timing controller. The output data signals may be applied to the pixels.

Therefore, each pixel may be turned on by the gate signal, and the turned-on pixel may receive the corresponding data voltage from the data driver and display an image of a desired grayscale.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

Tables 1 to 4 below show experimental results of observing scattering prevention effects, impact resistances and curvature reliabilities of a protecting cover according to embodiments and comparative examples. The scattering prevention effect value may indicate whether imperceptible glass fragments are scattered when the protecting cover is broken. The impact resistance value may indicate a height at which the protecting cover breaks when a pen of about 5.7 g is dropped onto the protecting cover. The curvature reliability value may indicate whether the protecting cover is peeled off when curved at a radius of curvature of about 4.5 mm.

Table 1 shows results of observation of scattering prevention effects, impact resistances and curvature reliabilities of a protecting cover while varying constituent materials and composition ratios of the coating layer provided on a cover substrate. In the following experiments, polyethylene terephthalate (PET) having a thickness of about 50 μm and modeling a display panel and a pressure-sensitive adhesive (PSA) having a thickness of about 50 μm were stacked on a steel sheet, and a coating layer having a thickness of about 10 μm and a cover substrate having a thickness of about 100 μm were stacked thereon. In the case of Table 1, a matrix forming the coating layer included polyurethane and rubber, and a filler included glass beads. In the following Table 1, a volume ratio of the matrix represents a ratio of a volume of the matrix to a sum of the volume of the matrix and a volume of the filler.

TABLE 1

| | Glass | Matrix | | Scattering | | |
|---|---|---|---|---|---|---|
| | bead | volume | | prevention | Impact | Curvature |
| | diameter | ratio | Transmittance | effect | resistance | Reliability |
| Embodiment 1 | 1 μm | 90% | 84% | Y | 7 cm | Y |
| Embodiment 2 | 0.7 μm | 90% | 81% | Y | 7 cm | Y |
| Embodiment 3 | 0.3 μm | 90% | 79% | Y | 7 cm | Y |
| Embodiment 4 | 0.1 μm | 90% | 76% | Y | 7 cm | Y |
| Embodiment 5 | 1 μm | 80% | 78% | Y | 10 cm | Y |
| Embodiment 6 | 0.7 μm | 80% | 74% | Y | 11 cm | Y |
| Embodiment 7 | 0.3 μm | 80% | 74% | Y | 12 cm | Y |
| Embodiment 8 | 0.1 μm | 80% | 71% | Y | 9 cm | Y |
| Comparative 1 | 1 μm | 70% | 53% | Y | 19 cm | N |
| Comparative 2 | 0.7 μm | 70% | 45% | Y | 18 cm | N |
| Comparative 3 | 0.3 μm | 70% | 32% | Y | 17 cm | N |
| Comparative 4 | 0.1 μm | 70% | 30% | Y | 17 cm | N |

Referring to Table 1, it can be seen that when the filler includes glass beads, transmittance is improved when the volume ratio of the matrix exceeded 70%. Since light may be diffracted in the glass beads, when the volume ratio of the glass beads is great, a transmittance of the entire coating layer may be reduced. The effect of reducing the transmittance by the glass beads was greater when the diameter of the glass beads was smaller. In the case of Comparative Examples 1 to 4 in which the volume ratio of the matrix was 70%, the transmittance was 60% or less. In addition, in the case of Comparative Examples 1 to 4, the adhesion of the coating layer was reduced and the curvature reliability was reduced accordingly. That is, the coating layers of Comparative Examples 1 to 4 peeled off when the protecting cover was curved at a radius of curvature of 4.5 μm. The impact resistance increased as the volume ratio of glass beads increased.

Table 2 shows results of observation of the scattering prevention effects, the impact resistances, and the curvature reliabilities of the protecting cover while varying the constituent materials and the composition ratios of the coating layer provided on the cover substrate. In the following experiment, the polyethylene terephthalate (PET) having the thickness of about 50 μm and modeling the display panel and the pressure-sensitive adhesive (PSA) having the thickness of about 50 μm were stacked on the steel substrate, and the coating layer having the thickness of about 10 μm and the cover substrate having the thickness of about 100 μm were stacked thereon. In the case of Table 2, the matrix forming the coating layer included polyurethane and rubber, and the filler included glass fibers. In Table 2 below, the volume ratio of the matrix indicates the ratio of the volume of the matrix to the sum of the volume of the matrix and the filler.

TABLE 2

| | Glass | Matrix | | Scattering | | |
|---|---|---|---|---|---|---|
| | fiber | volume | | prevention | Impact | Curvature |
| | diameter | ratio | Transmittance | effect | resistance | Reliability |
| Embodiment 9 | 3 μm | 90% | 91% | Y | 10 cm | Y |
| Embodiment 10 | 5 μm | 90% | 90% | Y | 14 cm | Y |
| Embodiment 11 | 3 μm | 80% | 90% | Y | 10 cm | Y |
| Embodiment 12 | 5 μm | 80% | 91% | Y | 19 cm | Y |
| Embodiment 13 | 3 μm | 70% | 91% | Y | 15 cm | Y |
| Embodiment 14 | 5 μm | 70% | 90% | Y | 20 cm | Y |

Referring to Table 2, when the glass fiber having a diameter of 3 μm to 5 μm was used as a filler, the transmittance, the shattering prevention effect, and the impact resistance, and the curvature reliability were excellent.

Table 3 shows results of observation of the scattering prevention effects, the impact resistances and the curvature reliabilities of the protecting cover while varying the constituent materials and the composition ratios of the coating layer provided on the cover substrate. In the following experiment, the polyethylene terephthalate (PET) having the thickness of about 50 μm and modeling the display panel and the pressure-sensitive adhesive (PSA) having the thickness of about 50 μm were stacked on the steel sheet, and the coating layer having the thickness of about 10 μm and the cover substrate having the thickness of 100 μm were stacked thereon. In the case of Table 3, the matrix forming the coating layer included polyurethane and rubber, and the filler included silica. In Table 3, the volume ratio of the matrix indicates the ratio of the volume of the matrix to the sum of the volume of the matrix and the volume of the filler.

TABLE 3

| | | Matrix | | Scattering | | |
|---|---|---|---|---|---|---|
| | Silica | volume | | prevention | Impact | Curvature |
| | diameter | ratio | Transmittance | effect | resistance | Reliability |
| Embodiment 15 | 5 nm | 90% | 90% | Y | 8 cm | Y |
| Embodiment 16 | 7 nm | 90% | 85% | Y | 10 cm | Y |
| Embodiment 17 | 10 nm | 90% | 88% | Y | 11 cm | Y |
| Embodiment 18 | 20 nm | 90% | 89% | Y | 12 cm | Y |
| Embodiment 19 | 5 nm | 80% | 78% | Y | 10 cm | Y |
| Embodiment 20 | 7 nm | 80% | 74% | Y | 11 cm | Y |
| Embodiment 21 | 10 nm | 80% | 74% | Y | 12 cm | Y |
| Embodiment 22 | 20 nm | 80% | 71% | Y | 15 cm | Y |
| Comparative 5 | 5 nm | 70% | 51% | Y | 19 cm | Y |
| Comparative 6 | 7 nm | 70% | 53% | Y | 18 cm | Y |
| Comparative 7 | 10 nm | 70% | 52% | Y | 17 cm | Y |
| Comparative 8 | 20 nm | 70% | 55% | Y | 17 cm | Y |

Referring to Table 3, it can be seen that when the filler included silica higher transmittance was obtained when the volume ratio of the matrix exceeded 70%. In the case of Comparative Examples 5 to 8 in which the volume ratio of the matrix was 70%, the transmittance was 60% or less. The impact resistance increased as the volume ratio of silica increased.

Table 4 shows results of experiments of transmittances, scattering prevention effects, impact resistances, and curvature reliabilities of a protecting cover without a coating layer (Comparative Example 9) and a protecting cover in which an optical clear adhesive (OCA) film is stacked on the cover substrate in place of a coating film according to the present disclosure (Comparative Example 10).

TABLE 4

| | | Scattering | Impact | Curvature |
|---|---|---|---|---|
| | Transmittance | prevention effect | resistance | Reliability |
| Comparative | 91.5% | N | 5 cm | Y |
| Example 9 | | | | |
| Comparative | 90.1% | Y | 3 cm | N |
| Example 10 | | | | |

In Comparative Example 9, although the transmittance was excellent, there was no scattering prevention effect due to the absence of the coating layer. The protecting cover of Comparative Example 9 had a lower impact resistance than the protecting cover having the coating layer according to the embodiment. In the case of Comparative Example 10, the OCA films were stacked to produce the scattering prevention effect. However, the OCA film did not contribute to improvement of the impact resistance. Further, the OCA film was peeled off from the cover substrate when the protecting cover was curved at a radius of curvature of 4.5 mm, and thus, there was no curvature reliability.

By way of summation and review, flexible display devices have bending and folding characteristics to be foldable or rollable. Thus, the flexible display device may have a large screen and still be easy to carry around. Such the flexible display device may be applied to various fields, specifically a television, a monitor, and the like in addition to mobile devices such as a mobile phone, a portable multimedia player (PMP), a navigation device, an ultra mobile PC (UMPC), an electronic book, and electronic newspapers.

According to embodiments, a protecting cover for a flexible display device having excellent durability and securing safety of a user may be provided. The protecting cover may have flexibility and prevent the scattering of fragments of glass. The display device having the protecting cover according to an embodiment may be included in various electronic devices. For example, the display device may be included in various devices such as televisions, notebooks, mobile phones, smart phones, smart pads, a portable multimedia players (PMPs), personal digital assistants (PDAs), navigation devices, smart watches, wearable devices including any of the above, or the like.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A protecting cover, comprising:
a cover substrate; and
a coating layer on the cover substrate,
wherein the coating layer includes a matrix and a filler embedded in the matrix.

2. The protecting cover as claimed in claim 1, wherein the matrix includes at least one of an epoxy acrylate resin, a polyester acrylate resin, a polyether acrylate resin, a urethane acrylate resin, an acrylic acrylate resin, an unsaturated polyester, a urethane resin, an acrylonitrile-butadiene-styrene (ABS) resin, and a rubber.

3. The protecting cover as claimed in claim 1, wherein the filler includes at least one of glass beads, glass fibers, and silica.

4. The protecting cover as claimed in claim 1, wherein:
the cover substrate includes at least one of glass, aluminosilicate, borosilicate, and boroaluminosilicate, and
the cover substrate includes an ion-exchanged chemical strengthening layer.

5. The protecting cover as claimed in claim 1, wherein the coating layer has an elastic modulus of 1.52 GPa to 5.0 GPa.

6. The protecting cover as claimed in claim 1, wherein a difference between a refractive index of the coating layer or a refractive index of the cover substrate and a refractive index of the filler is less than 0.3.

7. The protecting cover as claimed in claim 1, further comprising an adhesive layer on the coating layer.

8. The protecting cover as claimed in claim 7, wherein the adhesive layer has a storage modulus of 80 MPa to 120 MPa.

9. The protecting cover as claimed in claim 1, wherein the cover substrate has a thickness of 10 gam to 150 μm.

10. The protecting cover as claimed in claim 1, wherein the protecting cover is bendable to a radius of curvature of 4.5 mm or less without breaking or peeling of the cover substrate.

11. The protecting cover as claimed in claim 1, wherein a ratio of a volume of the matrix to a sum of the volume of the matrix and a volume of the filler is 80% to 100%.

12. The protecting cover as claimed in claim 1, wherein the protecting cover has an impact resistance of at least 6 cm in a test in which a pen of 5.7 g is dropped onto the protecting cover.

13. A display device, comprising:
a display panel displaying an image; and
a protecting cover provided on the display panel,
wherein the protecting cover includes:
a cover substrate; and
a coating layer on the cover substrate, the coating layer including a matrix and a filler.

14. The display device as claimed in claim 13, further comprising an adhesive layer between the coating layer and the display panel.

15. The display device as claimed in claim 13, wherein the coating layer is between the cover substrate and the display panel.

16. The display device as claimed in claim 13, wherein the display device has flexibility.

17. The display device as claimed in claim 13, wherein the matrix includes at least one of an epoxy acrylate resin, a polyester acrylate resin, a polyether acrylate resin, a urethane acrylate resin, an acrylic acrylate resin, an unsaturated polyester, a urethane resin, an acrylonitrile-butadiene-styrene (ABS) resin, and a rubber.

18. The display device as claimed in claim 13, wherein the filler includes at least one of glass beads, glass fibers, and silica.

19. The display device as claimed in claim 13, wherein:
the cover substrate includes at least one of glass, aluminosilicate, borosilicate, and boroaluminosilicate, and
the cover substrate includes an ion-exchanged chemical strengthening layer.
